(19) United States
(12) Patent Application Publication
(10) Pub. No.: US 2007/0008585 A1
(43) Pub. Date: Jan. 11, 2007

(54) Image processing device, image processing method, and image processing program

(75) Inventor: Nobuhiro Karito, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/478,176

(22) Filed: Jun. 28, 2006

(30) Foreign Application Priority Data
Jul. 5, 2005 (JP) 2005-196256

(51) Int. Cl. G06K 15/00

(52) U.S. Cl. 358/3.06; 382/251

(57) ABSTRACT

An image processing device, image processing method, and image processing program are provided, to obtain an output image in which the occurrence of unpleasant noise is suppressed. An image processing device, which divides an input image into pixel groups having a plurality of pixels and performs quantization processing in units of these pixel groups, has quantization unit which uses pixel groups, the shapes of which are point-symmetric, to convert input image data into output image data having two or more grayscales.

### CROSS-REFERENCE TO RELATED APPLICATIONS

This application is based upon and claims the benefit of priority from the prior Japanese Patent Application No. 2005-196256, filed on Jul. 5, 2005, the entire contents of which are incorporated herein by reference.

### BACKGROUND OF THE INVENTION

1. Field of the Invention

This invention relates to an image processing device, an image processing method, and an image processing program. More specifically, the invention relates to an image processing device and similar which performs quantization processing using cells the shapes of which have been rendered symmetrical.

2. Description of the Related Art

In the prior art, printers and other image processing devices use halftone processing of input image data having multivalued grayscale values for each pixel to convert the data into output image data with a smaller number of grayscales (for example, with two data values), to perform printing onto printing paper.

As halftone processing, dot-concentrated dithering methods (multivalued dithering methods) are known. In multivalued dithering methods, thresholds are distributed such that dots grow from the center of a matrix of prescribed size, and results are compared with input grayscale values.

However, in multivalued dithering methods, distribution of thresholds may for example cause the breaking of fine lines when there are fine lines in the input image, or may cause the occurrence of “jaggies” at edge portions of the input image, so that an image which is not true to the input image is output, and there are problems with image quality.

Hence in order to resolve these problems, methods have been proposed in which the center-of-gravity position is determined from grayscale values for each pixel within a cell comprising a plurality of pixels, and a dot corresponding to the sum of the grayscale values for each pixel is generated at the center-of-gravity position (see for example Japanese Patent Application No. 2004-137326; hereafter called the “AAM (Advanced AM screen) method”).

However, when using the AAM method, a dot is generated at the center-of-gravity position in a cell; but when the cell shape is asymmetrical, the cell center of gravity does not coincide with a pixel center, so that a slight change in the input image distribution causes the pixel position at which a dot is generated to move by one pixel. This scattering in dot positions results in unpleasant noise and appears in the output image.

### SUMMARY OF THE INVENTION

This invention was devised in light of the above problems, and has as an object the provision of an image processing device, image processing method, and image processing program to obtain output images in which the occurrence of unpleasant noise is suppressed.

In order to attain the above object, an image processing device of the present invention, which divides an input image into pixel groups having a plurality of pixels and performs quantization processing in units of the pixel groups, having a quantization unit which converts input image data into output image data having two or more grayscales, using the pixel groups the shapes of which are point-symmetric. Therefore, for example, if a dot is generated at the pixel of the center-of-gravity position of a pixel group, then even if there is a slight change in a uniform input grayscale distribution, the center-of-gravity position of the pixel group is positioned in proximity to the center of the dot generation pixel, so that there is no scattering in the pixel position of dot generation, and an output image is obtained in which unpleasant noise is suppressed.

The image processing device of the present invention, wherein at least one pixel constituting each of the pixel groups is common to a plurality of the pixel groups. Therefore, the shape of each pixel group is rendered symmetric, and an output image is obtained in which the occurrence of noise is suppressed.

Further, the image processing device of the present invention, wherein the pixel hold in common by the pixel groups is a pixel which is at an equal distance from the center of each of the pixel groups. Therefore, the number of pixels common to pixel groups can be made small, and increases in the amount of processing due to common pixels can be reduced.

Further, the image processing device of the present invention, wherein a commonality level is set for each pixel constituting the pixel groups, and for the common pixel, the commonality level is set according to the number of the pixel groups to which the common pixel is common. Therefore, for example, a common pixel is equally divided among a plurality of pixel groups, and the shapes of pixel groups can be rendered symmetrical.

Further, the image processing device of the present invention, wherein the quantization unit having a center-of-gravity position determination unit which determines the center-of-gravity position of the pixel groups from values obtained by multiplying the input image data for each of the pixels included in the pixel group by the commonality level, a positioning unit which positions the center of a multivalued dithering matrix, applied in units of the pixel groups, at the center-of-gravity position of the pixel group, and an output unit which compares the multivalued dithering matrix with the input image data for each of the pixels included in the pixel group, to obtain the output image data. Therefore, the center-of-gravity position is determined using the value obtained by for example multiplying the commonality level by the input image data for each pixel, so that the influence on the accurate center-of-gravity position of common pixels due to processing for a plurality of pixel groups can be reduced.

Further, the image processing device of the present invention, wherein table numbers of tables indicating the correspondence relation between the input image data and the output values are stored in the multivalued dithering matrix, and the output unit references the table number of the multivalued dithering matrix corresponding to the position of each pixel included in the pixel group to obtain output values from the input image data, and outputs, as the output image data, values obtained by multiplying the output values by the commonality level. Therefore, even when for example the output values of common pixels are added a plurality of times for a plurality of pixel groups, output image data can be held within the range of a maximum number of grayscales.

Further, the image processing device of the present invention, wherein the output unit ends the quantization processing in the pixel group when an ideal grayscale value has been obtained based on the sum of values obtained by multiplying the input image data for each pixel in the pixel group by the commonality level. Therefore, when for example the ideal grayscale value which is the sum of the input image data for the pixel group is determined, by using value obtained by multiplying the input image data by a contribution factor, the input image data for each pixel can be regarded as belonging to the pixel group according to its contribution factor, and so output which is true to the input grayscale information can be obtained.

Further, the image processing device of the present invention, wherein the output unit comprises a supplement unit which, when an ideal grayscale value based on the sum of values obtained by multiplying the input image data for each pixel in the pixel group by the commonality levels is not obtained, performs supplement processing such that the sum of the input image data in the pixel group becomes substantially the ideal grayscale value. Therefore, when for example the ideal grayscale value which is the sum of the input image data for the pixel group is determined, by using a value obtained by multiplying the input image data by the contribution factor, the input image data for each pixel can be regarded as belonging to the pixel group according to the contribution factor, and output which is true to the input grayscale information can be obtained.

Further, in order to attain the above objects, an image processing device of the present invention, which divides an input image into pixel groups having a plurality of pixels and performs quantization processing in units of the pixel groups, having a quantization unit, which converts input image data into output image data having two or more grayscales, using the pixel groups in which the center position of the pixel group and the center position of any pixel included in the pixel groups coincide. Therefore, for example, if a dot is generated at the pixel of a pixel group at which the center-of-gravity position exists, then even if the uniform input grayscale distribution changes slightly, the center-of-gravity position of the pixel group is positioned in proximity to the center of the pixel at which the dot was generated, so that there is little scattering in the position of the pixel of dot generation, and an output image is obtained in which unpleasant noise is suppressed.

Further, in order to attain the above objects, an image processing method of the present invention, which divides an input image into pixel groups having a plurality of pixels and performs quantization processing in units of the pixel groups, having the step of converting input image data into output image data having two or more grayscales, using the pixel groups the shapes of which are point-symmetric.

Further, in order to attain the above objects, an image processing method of the present invention, which divides an input image into pixel groups having a plurality of pixels and performs quantization processing in units of the pixel groups, having the step of converting input image data into output image data having two or more grayscales, using the pixel groups in which the center position of the pixel grous and the center position of any pixel included in the pixel group coincide.

Further, in order to attain the above objects, an image processing program of the present invention, which divides an input image into pixel groups having a plurality of pixels and performs quantization processing in units of the pixel groups, the image processing program causing a computer to execute processing to convert input image data into output image data having two or more grayscales, using the pixel groups the shapes of which are point-symmetric.

Further, in order to attain the above objects, an image processing program of the present invention, which divides an input image into pixel groups having a plurality of pixels and performs quantization processing in units of the pixel groups, the image processing program causing a computer to execute processing to convert input image data into output image data having two or more grayscales, using the pixel groups, in which the center position of the pixel group and the center position of any pixel included in the pixel group coincide.

### BRIEF DESCRIPTION OF THE DRAWINGS

FIG. 1 shows the overall configuration of a system to which this invention is applied;

FIG. 2 shows another configuration of an image processing device;

FIG. 3 shows examples of cell shapes;

FIG. 4 is a diagram used to explain the contribution factor;

FIG. 5 is a flowchart showing operation for processing in a cell;

FIG. 6 is a flowchart showing operation for processing in a cell;

FIG. 7 shows an example of input data, input data in cells, and data multiplied by the contribution factor;

FIG. 8 shows an example of center-of-gravity positions and processing order in a cell;

FIG. 9 shows an example of an index matrix and an example of a gamma table;

FIG. 10 shows examples of output buffers;

FIG. 11 shows an example of input data, input data in a cell, and data multiplied by the contribution factor;

FIG. 12 shows an example of a center-of-gravity position, processing order, and index matrix;

FIG. 13 shows an example of an output buffer;

FIG. 14 shows an example of input data, input data in a cell, and data multiplied by the contribution factor;

FIG. 15 shows an example of a center-of-gravity position, processing order, and index matrix;

FIG. 16 shows examples of output buffers;

FIG. 17 shows the overall configuration of another system to which this invention is applied; and,

FIG. 18 shows the overall configuration of another system to which this invention is applied.

### DESCRIPTION OF THE PREFERRED EMBODIMENTS

### First Embodiment

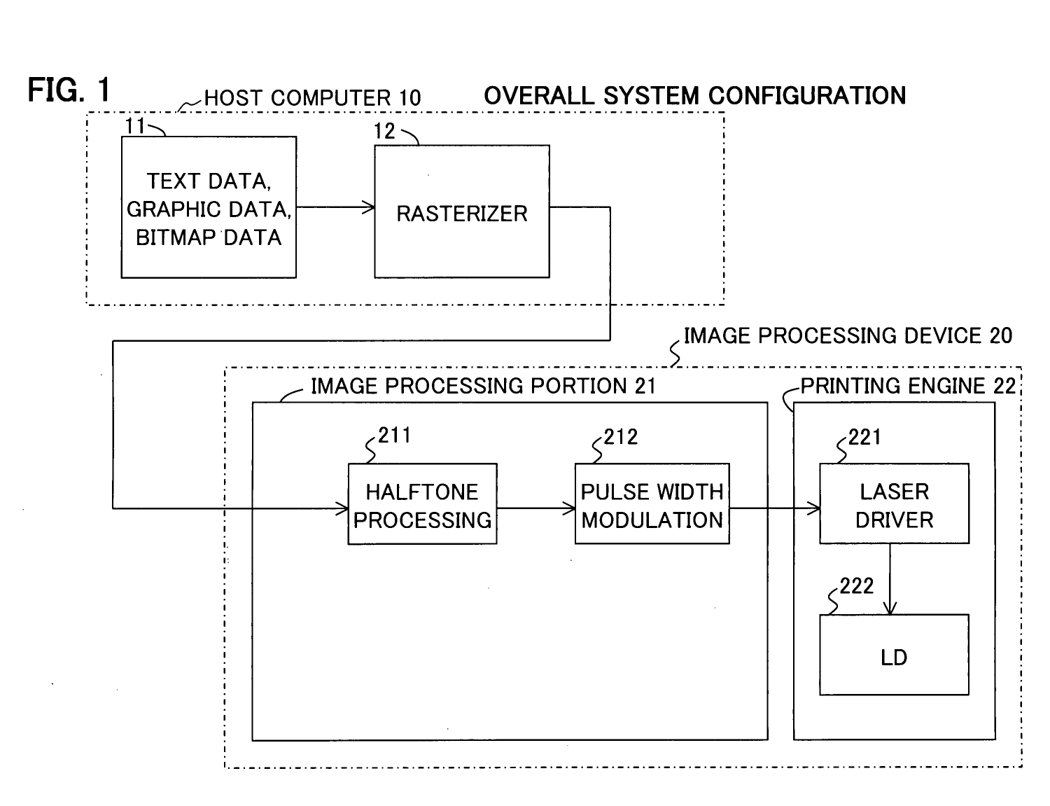

Below, preferred embodiments for implementation of the invention are explained, referring to the drawings. FIG. 1 shows the overall configuration of a system to which this invention is applied. This system as a whole comprises a host computer 10 and an image processing device 20.

The host computer 10 comprises an application portion 11 and a rasterizing portion 12.

The application portion 11 generates text data, graphical data, or other data for printing by means of a word processor, graphics tool, or other application program. The rasterizer portion 12 converts each pixel (or dot) of the data for printing into 8-bit input image data, and outputs the result to the image processing device 20. Hence the input image data has, for each pixel, grayscale values ranging from “0” to “255”.

The image processing device 20 comprises an image processing portion 21 and a printing engine 22. The image processing portion 21 comprises a halftone processing portion 211 and a pulse width modulation portion 212.

The halftone processing portion 211 takes as input the input image data from the host computer 10, and converts this data into output image data having quantized data of two or more types. The pulse width modulation portion 212 generates driving data for this quantized data indicating, for each dot, whether there is or is not a laser driving pulse, and outputs the result to the printing engine 22.

The printing engine 22 comprises a laser driver 221 and a laser diode (LD) 222. The laser driver 221 generates control data for this driving data indicating whether there are or are not driving pulses, and outputs this data to the LD 222. The LD 222 is driven based on the control data, and the printing data generated by the host computer 10 is actually printed onto paper through driving of a photosensitive drum or similar.

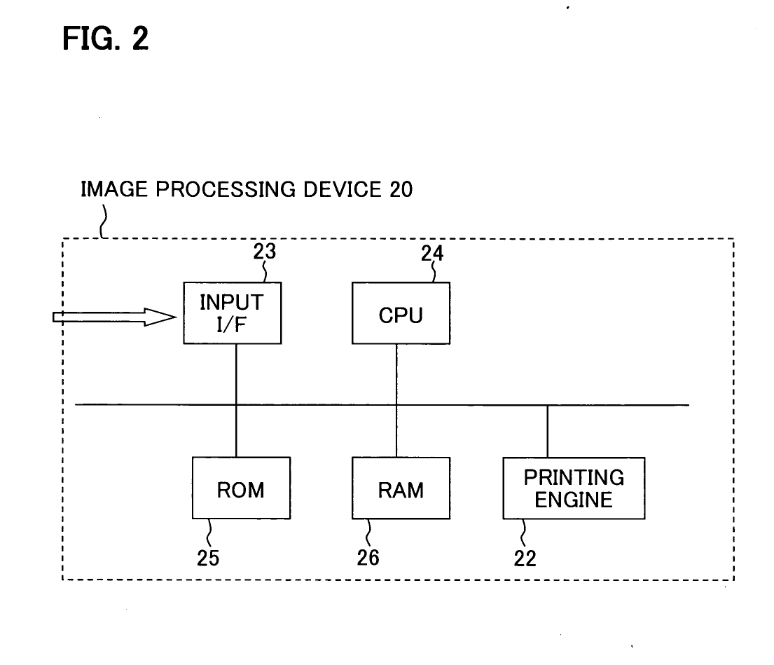

This invention may be applied to an image processing device 20 configured as hardware as shown in FIG. 1, or may be applied as software in an image processing device 20 as shown in FIG. 2. Here, the CPU 24, ROM 25, and RAM 26 correspond to the halftone processing portion 211 and pulse width modulation portion 212 in FIG. 1.

Next, details of halftone processing in this invention are explained; prior to this, however, a simple summary of this invention is given.

First, an input image is divided in advance into pixel groups (hereafter called “cells”) comprising a plurality of fixed (predetermined) pixels. This is in order to perform processing in cell units. Then, an index matrix, in which are stored table numbers for gamma tables to be referenced, is applied to these cells. Then, by referencing the gamma tables, output grayscale values corresponding to the input grayscale values are obtained for each pixel, and dots are generated.

A characteristic of this invention is the fact that the cells are rendered symmetrical. By rendering cells symmetrical, the center position of a cell coincides with the center position of one of the pixels within the cell. When an input image with uniform grayscales is provided, the center position of the cell becomes the center-of-gravity position, and if a dot is generated at the pixel at which the center-of-gravity position exists, the dot is generated at the center of the pixel.

In this state, even if there is a slight change in the grayscales of the input image, the center-of-gravity position is in the proximity of the center of a pixel, and so there is no shift in the position of the pixel at which the dot is generated itself, and dot scattering can be suppressed. As a result, an output image with noise suppressed is obtained.

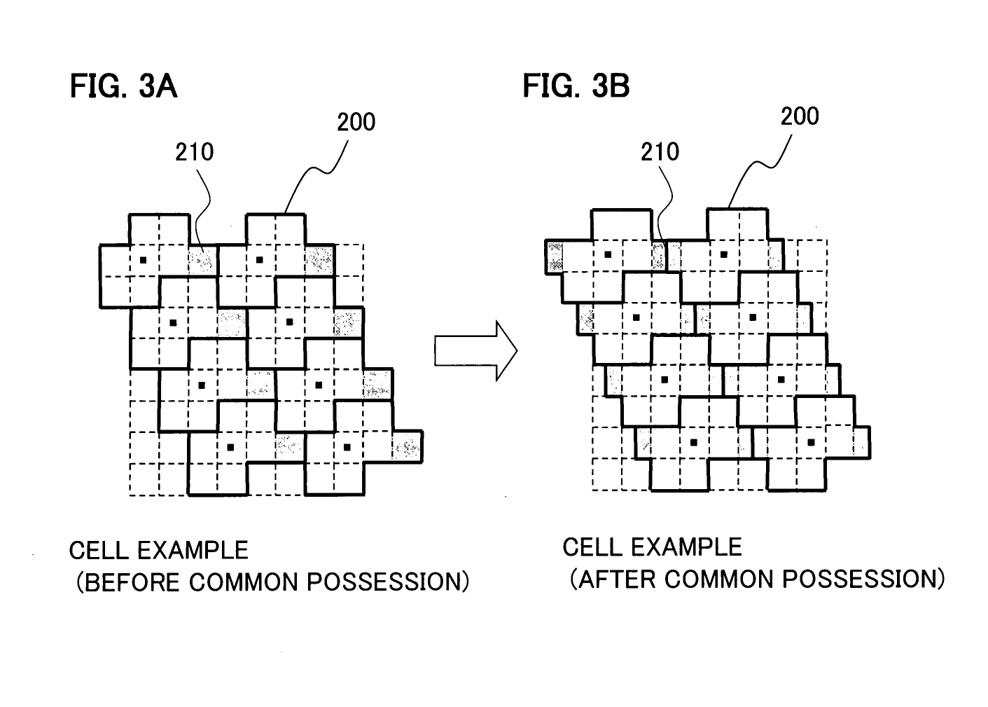

The symmetrical rendering of the cell shape is realized through the common possession by each cell of pixels at an equal distance from the center pixels of the cells. FIG. 3 shows an example of cell shapes before common possession, and after common possession. Common pixels 210 are possessed in common by cells 200 on the right and on the left, as shown in (B) of FIG. 3, and are quasi-divided into equal parts.

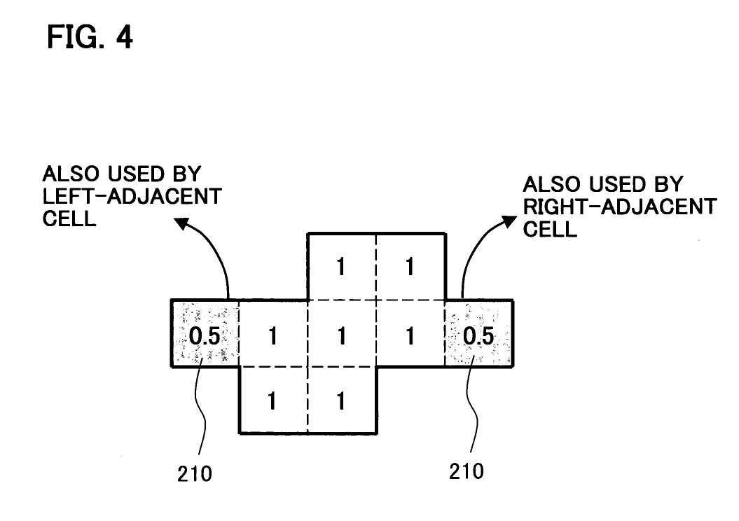

In order to divide common pixels 210 into equal parts, the fraction (contribution factor, commonality level) of a pixel belonging to a cell 200 is assigned to each pixel of the cell 200. An example of this appears in FIG. 4. The common pixel 210 on the left end is common with the cell 200 adjacent to the left, and the common pixel 210 on the right end is common with the cell 200 adjacent to the right. In this example, the common pixels 210 are cells processed in two cells 200, and so the contribution factor is “0.5”. The sum of the contribution factors for a pixel is “1” for all pixels.

The cells 200 shown in FIG. 3 are determined as follows. First, mesh point center positions (dot center positions; indicated by black points in the figures) are chosen at positions at which Moire generation is suppressed. The pixel positioned at the dot center position is included within the cell 200. Then, the distances of the center position of a certain pixel from dot center positions are compared, and a cell 200 is constructed such that the pixel is included in the cell with the closest dot center position. In this case, as shown in (A) of FIG. 3, there exist pixels which are at equal distances from two dot center positions; in this case, the pixels are included in one of the cells 200 (in this example, the cells on the left). In this state, noise occurs in the output image, and so cells 200 are constructed which have symmetrical shapes, as shown in (B) of FIG. 3.

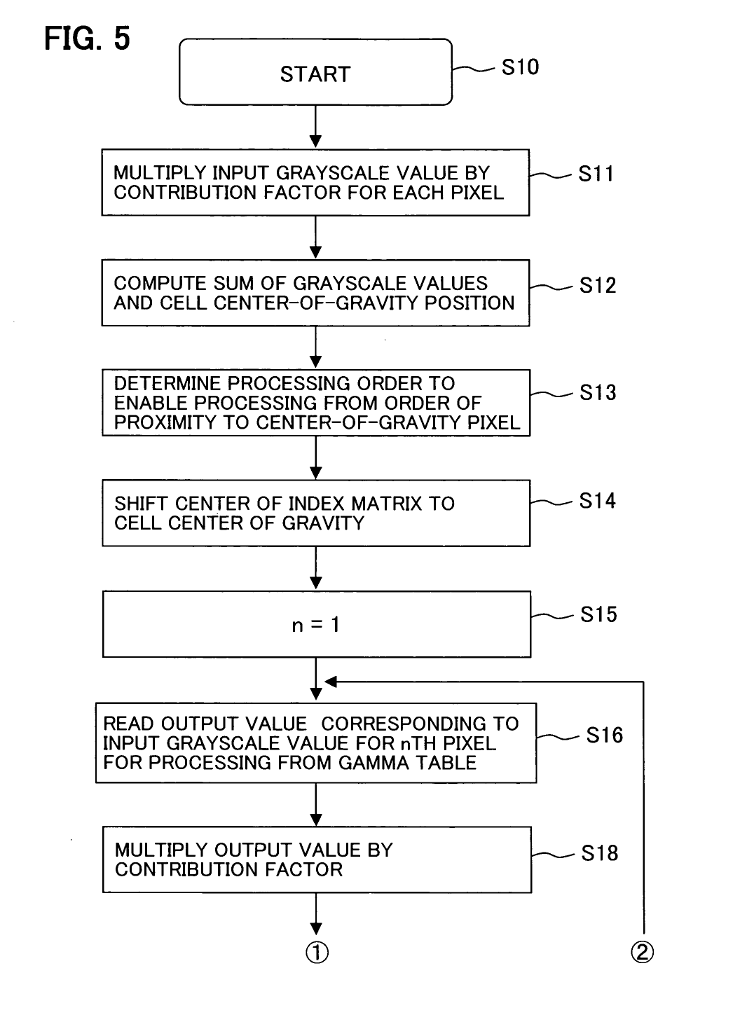

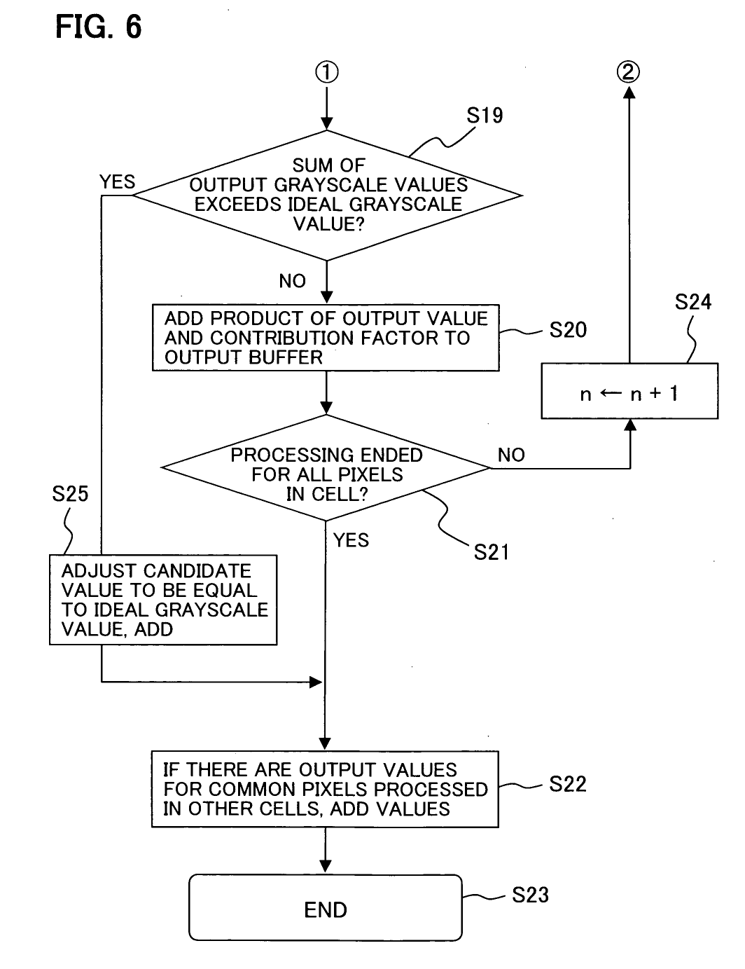

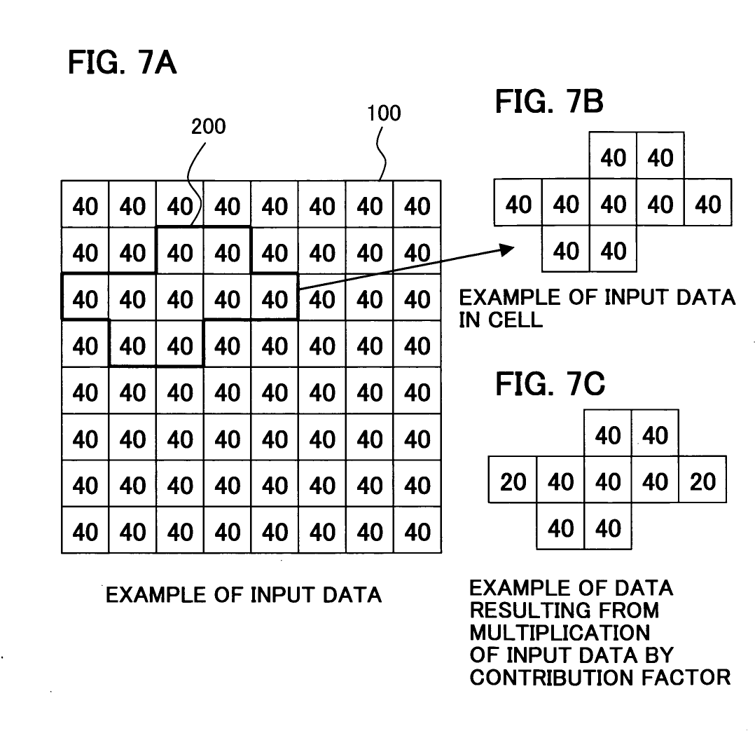

Next, the operation of halftone processing using such cells 200 is explained. FIG. 5 and FIG. 6 are flowcharts of processing in a cell 200. This Embodiment 1, as shown in (A) of FIG. 7, is an example of input of uniform grayscale data; it is assumed that at a certain time, the cell 200, indicated by the bold line, is to be processed.

First, the CPU 24 reads from ROM 25 a program to execute this processing, and initiates the processing (S10).

Next, the CPU 24 multiplies the input grayscale values for each pixel by the contribution factor (S11). For example, in the example shown in (B) of FIG. 7, the value for a pixel with contribution factor “1” is “40”, and the value for a pixel with contribution factor “0.5” is “20” (see (C) of FIG. 7).

Next, the CPU 24 computes the sum of the grayscale values within the cell 200 and the center-of-gravity position of the cell 200 (S12).

In computing the sum of grayscale values and center-of-gravity position 110, values obtained by multiplying the input grayscale values by contribution factors are used. Multiplied values are used in consideration of the facts that the grayscale values of each of the pixels in the cell 200 belong to the cell 200 to the extent of the contribution ratio, and that common cells 210 are processed in a plurality of cells 200, so that if the input grayscale values are used without modification, an accurate center-of-gravity position 110 cannot be computed for the cell 200.

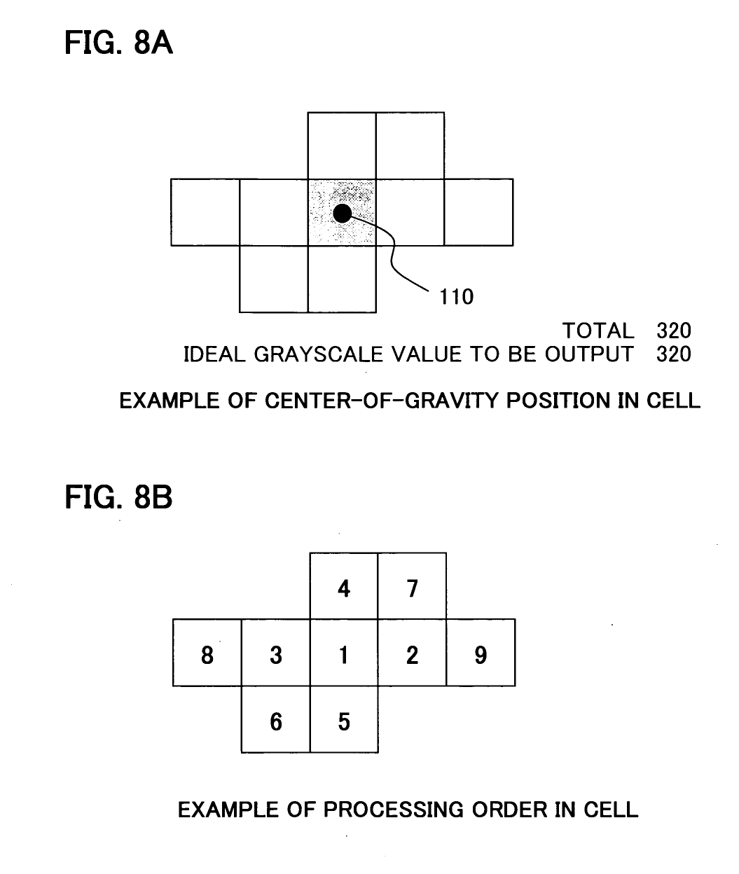

In the example of FIG. 7, the sum value is “320”, and the center-of-gravity position is the position indicated by the black circle in (A) of FIG. 8. The center-of-gravity position 110 is computed using the following formulae.
X_{center-of-gravity}=Σ{(X coordinate of pixel)×(grayscale value of pixel)}/sum of grayscale values in cell
Y_{center-of-gravity}=Σ{(Y coordinate of pixel)×(grayscale value of pixel)}/sum of grayscale values in cell

Next, the CPU 24 determines a processing order enabling processing in order from the pixels existing closest to the center-of-gravity position 110 (S13). In the example of FIG. 7, the order is as shown in (B) of FIG. 8.

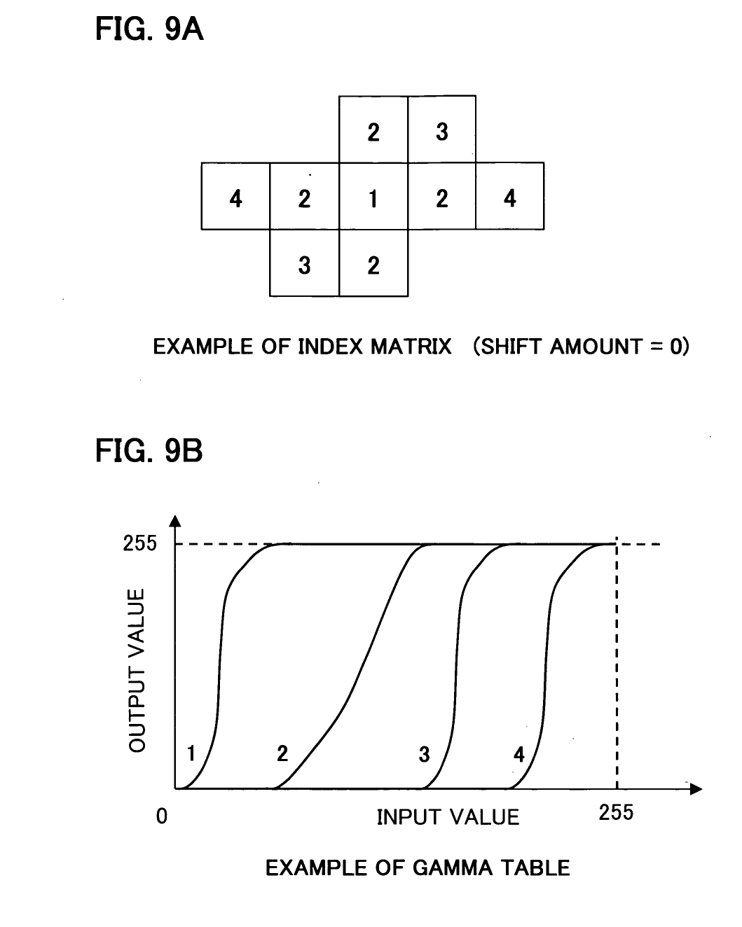

Next, the CPU 24 shifts the center position of the index matrix such that the center position of the matrix is positioned at the center-of-gravity position 110 of the cell 200 (S14). This is because, by causing the center-of-gravity position 110 to coincide with the pixel position at which a dot is most easily generated in the matrix, a dot can be more easily generated at the center-of-gravity position 110. In the above example, the shift amount to cause the center-of-gravity position 110 and the center of the cell 200 to coincide is (0,0). An example of an index matrix after shifting appears in (A) of FIG. 9.

Next, the CPU 24 allocates output grayscale values for each pixel according to the previously determined processing order. That is, “1” is substituted for “n” indicating the order of processing of pixels (S15), and the output value corresponding to the input grayscale value for the “n”th processed pixel is read from the gamma table (S16). In the above example, the index value for the “1”st pixel is “1” (see (B) of FIG. 8 and (A) of FIG. 9), and the input grayscale value is “40” (see (B) of FIG. 7), so that the output value corresponding to the input grayscale value “40” in the gamma table for number “1” is read (in this example, “255”).

In this embodiment, when referencing the gamma table, an output value is not determined by multiplying the input grayscale value by the contribution factor, but instead the output value is obtained from the input grayscale value itself. This is because if a value obtained by multiplication by the contribution factor is used, the input/output relation assumed in the gamma table at the design stage is destroyed.

Next, the CPU 24 multiplies the output value by the contribution factor (S18). In the above example, “255” is multiplied by the contribution factor “1”.

The output value obtained from the gamma table is multiplied by the contribution factor because common pixels 210 are processed a plurality of times for a plurality of cells 200, and if the value is not multiplied by the contribution factor, the maximum grayscale value of the common pixels 210 exceeds “255”.

Next, the CPU 24 adds the value multiplied by the contribution factor (hereafter the “candidate value”) to the sum of grayscale values already output, and judges whether the value exceeds the ideal grayscale value (S19 in FIG. 6). The ideal grayscale value is the sum of values obtained by multiplying input grayscale values by contribution factors, in a cell 200 in this embodiment. In the example of FIG. 7, the ideal grayscale value is “320”. This is done because, if processing is ended when output grayscale values are obtained to the extent of the ideal grayscale value, generation of a dot larger (thicker) than necessary can be prevented.

Hence the CPU 24 adjusts the candidate value such that when the ideal grayscale value is exceeded (YES), the value is equal to the ideal grayscale value, and adds the result to the output buffer (S25). On the other hand, if the ideal grayscale value is not exceeded (NO in S19), the candidate value is added without modification to the output buffer (S20).

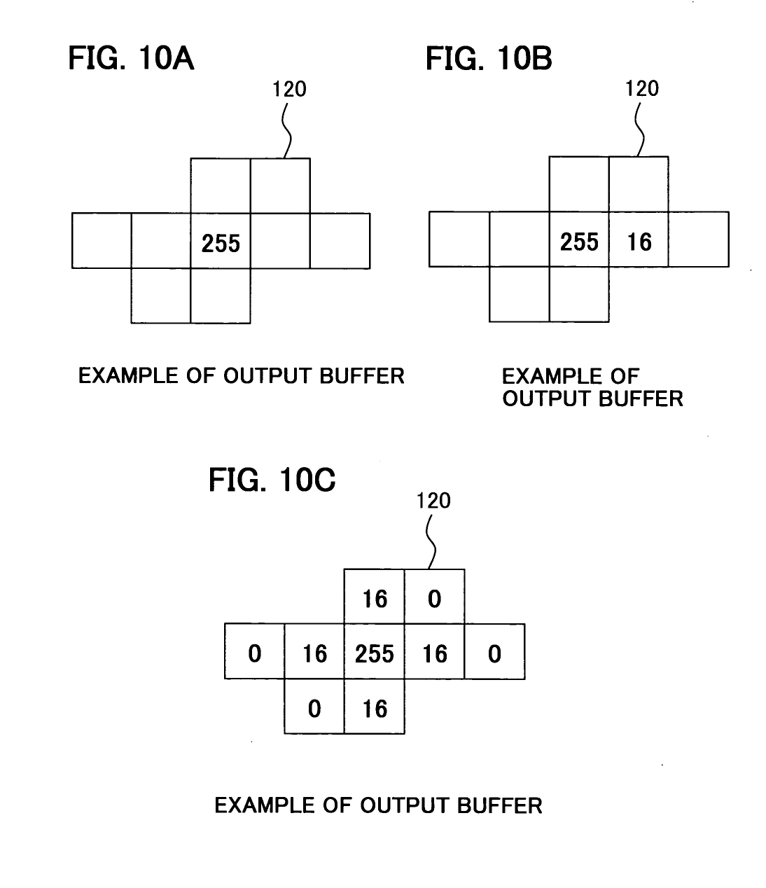

In the above example, the ideal grayscale value “320” is not exceeded even when the sum “0” of output grayscale values is added to the candidate value “255”. Hence the candidate value “255” is added without modification to the output buffer 120. This example appears in (A) of FIG. 10. The output buffer is a buffer which stores output grayscale values (quantization data), and corresponds for example to RAM 26.

Next, the CPU 24 judges whether processing has ended for all the pixels in the cell 200 (S21), and if processing has not ended (NO), adds “1” to the value of “n” indicating the processing order (S24), and again returns to S16.

In the above example, processing proceeds to the “2”nd pixel (see (B) in FIG. 8), and because the index value of the pixel is “2” (see (A) of FIG. 9) and the input grayscale value is “40” (see (B) of FIG. 7), the second gamma table is referenced and the output value “16” is read (S16).

Even when the output value “16” is multiplied by the contribution factor “1” and the result added to the output buffer 120, the value becomes “271” and does not exceed the ideal grayscale value of “320” (NO in S19). Hence the entire value “16” is added (S20). This example appears in (B) of FIG. 10.

Below, similar processing is repeated to obtain the output values shown in (C) of FIG. 10.

If there is already an output value for a common pixel 210 as a result of processing of another cell 200 (if there has been output to the output buffer 120), the CPU 24 adds this output value to the output value obtained as described above, and outputs the result to the output buffer 120 (S22).

Then, the CPU 24 ends processing for the cell 200 (S23). Process of the next cell 200 is then executed by repeating processing from S10.

### Second Embodiment

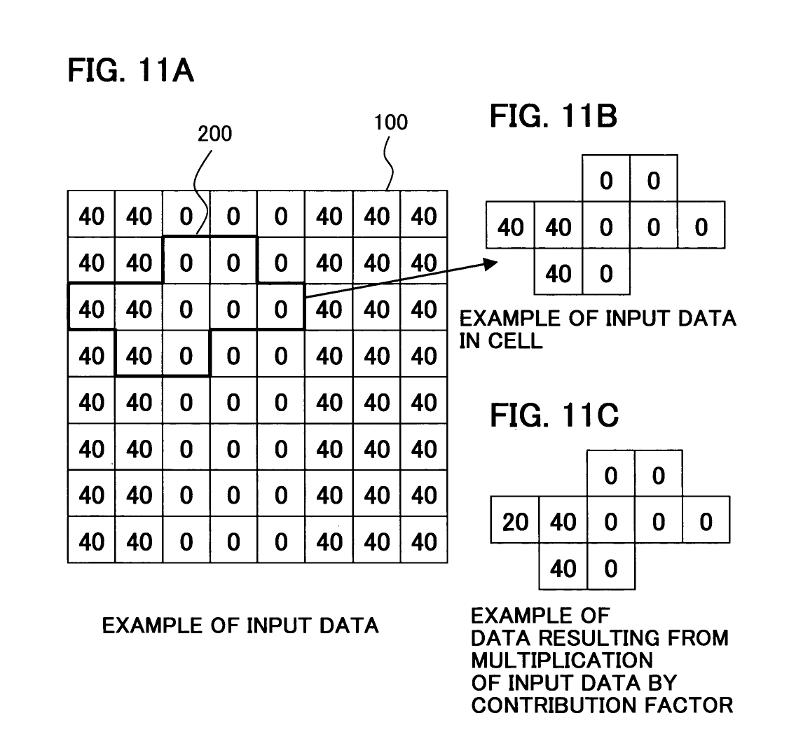

In the first embodiment, a case of input of uniform grayscale data was explained. In this second embodiment, an example in which grayscale values are concentrated on the left side of the cell 200 is explained. This example appears in (A) of FIG. 11. The cell 200 indicated by the bold line is taken to be the cell for processing at a certain time. Input data in the cell 200 is distributed as shown in (B) of FIG. 11.

First, the CPU 24 multiplies input grayscale values by contribution factors (S11; see (C) of FIG. 11).

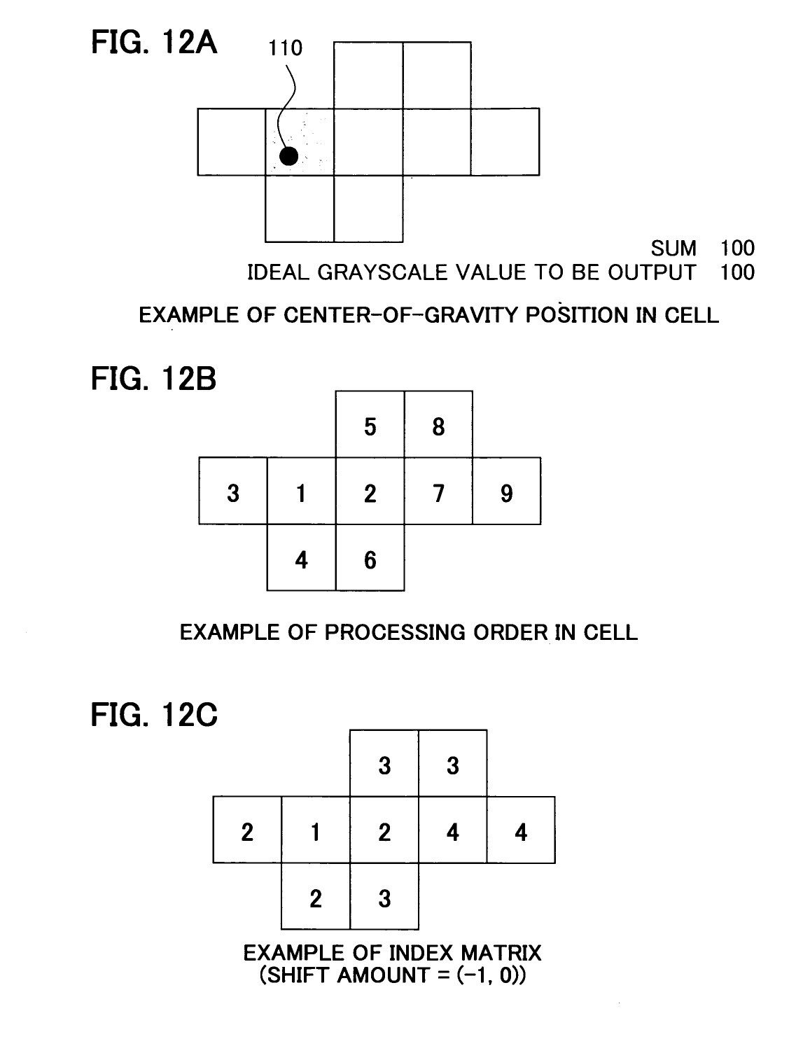

Next, the CPU 24 computes the sum of grayscale values using the multiplied values (computes the ideal grayscale value) and computes the center-of-gravity position 110 (S12; see (A) in FIG. 12).

Next, the CPU 24 determines the order of processing, starting from pixels closer to the center-of-gravity pixel (S13; see (B) in FIG. 12).

Next, the CPU 24 shifts the center of the index matrix (S14). In the case of this example, the center-of-gravity position 110 is shifted one pixel to the left of the pixel at the center position of the index matrix. Hence the matrix center is shifted by (−1,0). An example of a matrix after shifting appears in (C) of FIG. 12.

Then, the CPU 24 allocates output values to each pixel according to the processing order thus determined. Because the index value is “1” and the input grayscale value is “40” for the first pixel to be processed, the output value “255” corresponding to the input value “40” is read from the first gamma table (S16).

Then, the CPU 24 multiplies the output value “255” by the contribution factor “1”, and adds “255” to the output buffer 120 (S18).

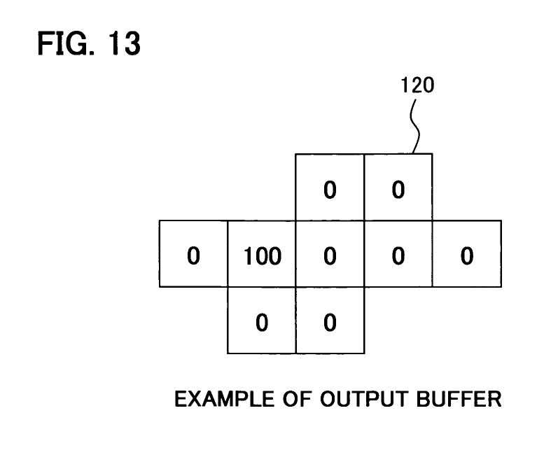

In this case, the added value “255” exceeds the ideal grayscale value “100” (YES in S19), and so the CPU 24 does not add the unmodified output value “255” to the output buffer 120, but instead adds the value “100” necessary to reach the ideal grayscale value (S25). Then, processing ends (S23). The output buffer 120 after the end of processing appears in FIG. 13.

In this Embodiment 2 also, similarly to Embodiment 1, computations are performed using the value obtained by multiplying the input grayscale value by the contribution factor when computing the sum of input grayscale values for a cell 200 and when computing the center-of-gravity position 110 of a cell 200. As the input value when referencing a gamma table, the input grayscale value itself is used to obtain the output value. Further, when referencing a gamma table to obtain an output value, the value obtained by multiplying the contribution factor by the output value from the table is employed to obtain output to the extent of the ideal grayscale value.

Advantageous results of the action of this Embodiment 2 are similar to those of Embodiment 1.

### Third Embodiment

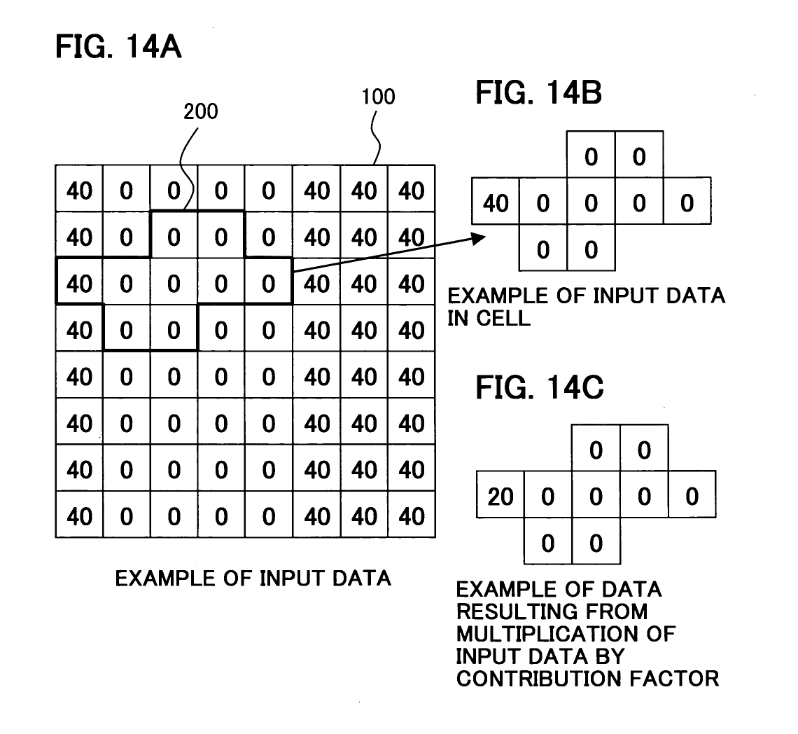

This third embodiment is an example of a case in which grayscale values exist only in the common pixels 210 of cells 200. An example of input data appears in (A) of FIG. 14. Similarly to the above, a case is explained in which the cell 200 indicated by the bold line is to be processed at a certain time.

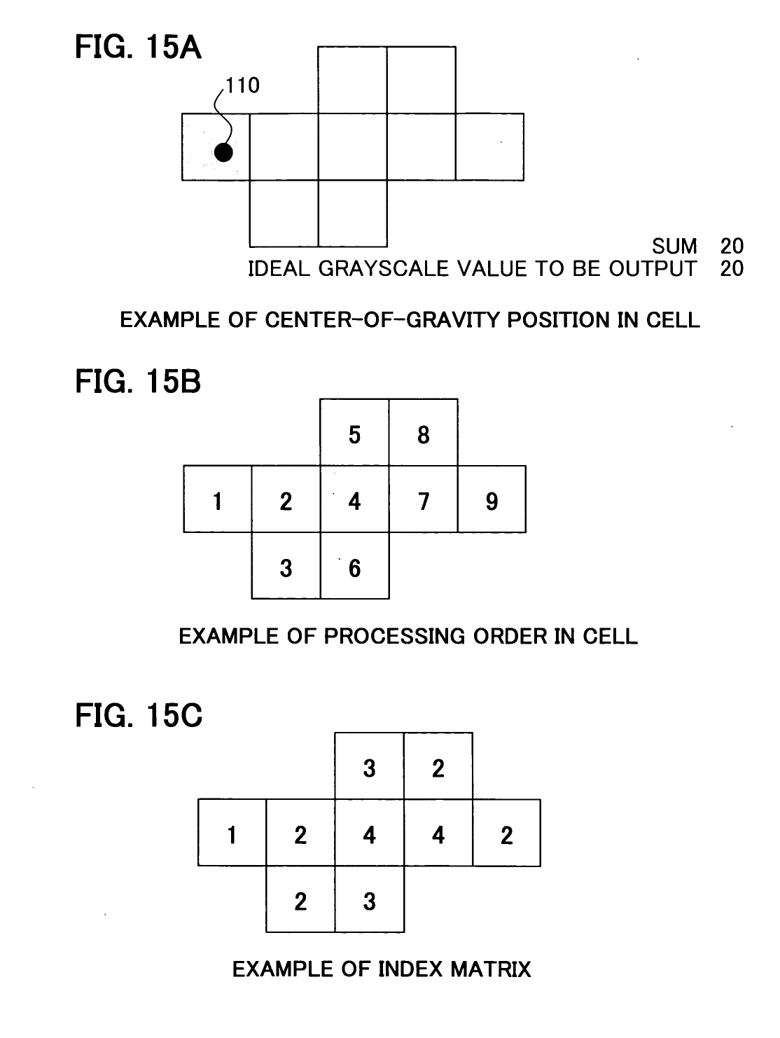

When the contribution factor is multiplied by the input grayscale value for each pixel (S11), the data shown in (C) of FIG. 14 is obtained. Upon using values multiplied by contribution factors to compute the sum of grayscale values and the center-of-gravity position 110 (S12), (A) in FIG. 15 is obtained. The center-of-gravity position 110 is positioned at a common pixel 210 two pixels to the left of the center of the cell 200.

The processing order is determined (S13; see (B) of FIG. 15), the index matrix is shifted by (−2,0) (S14; see (C) of FIG. 15), and output values are allocated in the order thus determined.

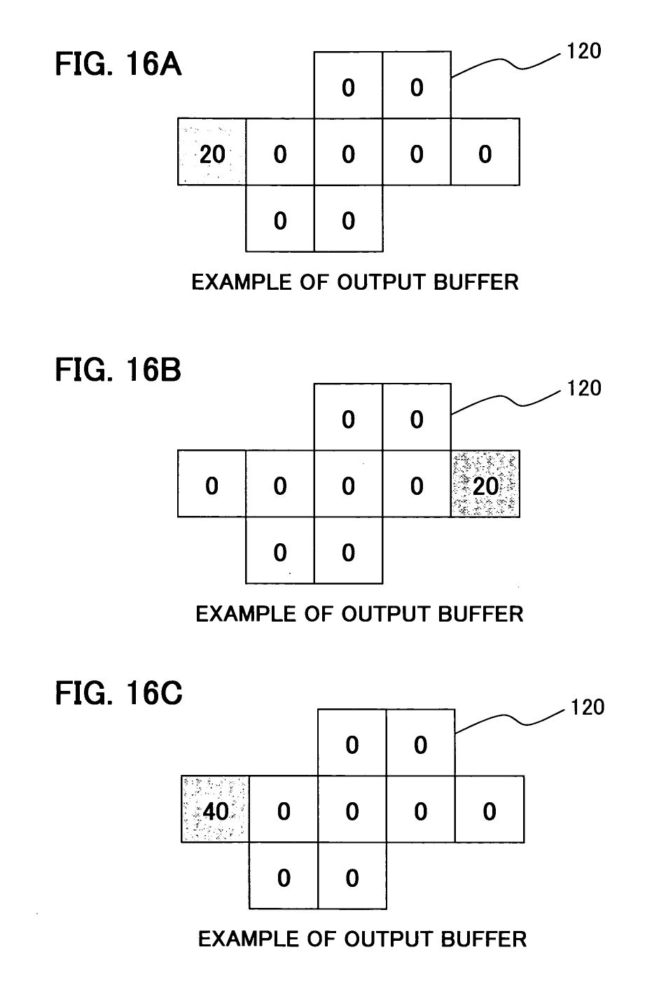

That is, the output value “255” corresponding to the input grayscale value “40” is read from the gamma table for the common pixel 210 (S16). The contribution factor is multiplied to obtain the candidate value “127” (S18), and because this exceeds the ideal grayscale value “20” (YES in S19), only the “20” necessary to reach the ideal grayscale value is added to the output buffer 120 (S25; see (A) of FIG. 16).

This common pixel 210 is also processed by the cell 200 adjacent on the left. As an example, suppose that as a result of processing for the cell 200 adjacent on the left, the output value shown in (B) of FIG. 16 is obtained.

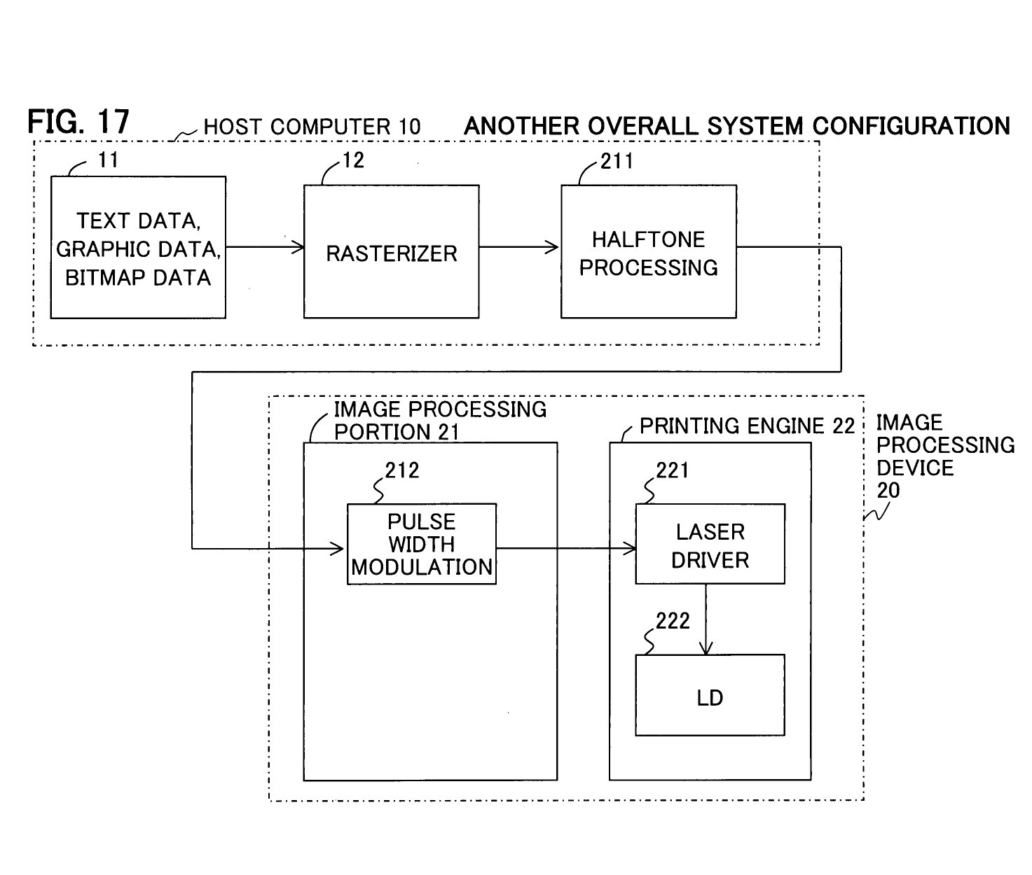

In this case, there exist, for the common pixel 210, the output value “20” for the cell 200 adjacent on the left, and the output value “20” for the cell 200 in question. In this case, the sum “40” of these output values is output as the output grayscale value for the common pixel 210 (S22; see (C) of FIG. 17). This “40” is equal to the input grayscale value “40” for the common pixel 210. That is, the grayscale value which was originally to be output is output.

Because the value for a common pixel 210 is added a plurality of times as a pixel for processing by different cells, if the output values obtained from gamma tables are added without modification, the maximum value “255” is exceeded. As explained above, by multiplying output values by a contribution factor and adding the results, the output grayscale values can be kept within the range from “0” to “255”.

In this Embodiment 3 also, advantageous results of action similar to those of Embodiments 1 and 2 are obtained.

### Other Embodiments

In the above-described examples, output values were obtained from input grayscale values by referring to gamma tables. In addition, output values may be obtained by processing using so-called multivalued dithering methods.

By rendering cells 200 symmetrical, the center of a cell 200 coincides with the center of a pixel, so that even if there is a slight shift from a uniform input grayscale distribution, there is no shift in the pixel position for dot generation, and an output image is obtained with noise suppressed. If cells 200 are rendered symmetrical, in addition to processing using a multivalued dithering method, processing by the AAM method may also be performed.

Further, in the above examples processing was performed taking the contribution factor for common pixels 210 to be “0.5”. This is because a common pixel 210 was a pixel which was processed in two cells 200. Hence when a pixel is common to three cells 200, the contribution factor is “⅓”, and for four cells 200 the value is “0.25”. The commonality level may be set according to the number of cells 200 to which a common pixel 210 is common. In this case also, advantageous results similar to those of the above examples are obtained.

Further, in the above examples, even when during processing in each cell 200 the sum of grayscale values which have been output does not reach the ideal grayscale value, at the end of processing of all pixels in the cell 200, processing ends for the cell 200 (NO in S19, YES in S21). Hence there are also cases in which the output grayscale value in a cell 200 does not reach the ideal grayscale value. In this case, processing may be performed to distribute the grayscale value deficiency to pixels close to the center-of-gravity position 110 for which there has been no dot output; or, the output value may be reset, and for example processing performed using a dithering matrix which a higher dot density than the multivalued dithering matrix (high-line number multivalued dithering processing), or, supplementary processing may be performed to redistribute ideal grayscale values in the cell 200 in the order of pixels with large input grayscale values, so as to obtain output values which substantially coincide with ideal grayscale values.

Further, in the above examples it was explained that the halftone processing of this invention is performed by an image processing device 20; but as shown in FIG. 17, processing may be performed by a host computer 10. In this case, the host computer 10 functions as the image processing device of this invention.

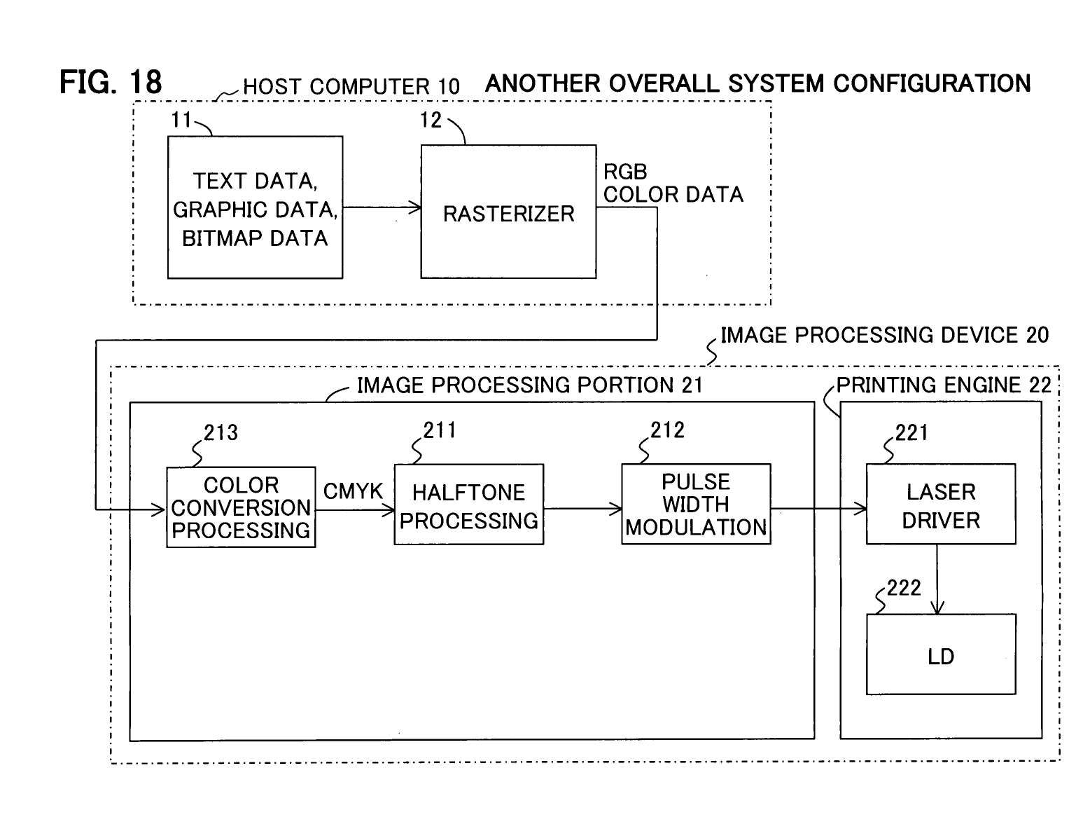

The above examples are explained assuming monochromatic data as the input image data. In addition, this invention may be applied to CMYK color data, as shown in FIG. 18.

In this case, the rasterizing portion 12 outputs RGB color data, and a color conversion processing portion 213 within the image processing device 20 converts this into CMYK color data. In this case, in this invention the above-described processing is repeated for each CMYK plane.

The color conversion processing portion 213 may be provided in the host computer 10; or, the color conversion processing portion 213 and halftone processing portion 211 may be provided in the host computer 10. In either case, advantageous results similar to those of the above examples are obtained.

Further, in the above examples the number of grayscales of the input image data was 256 (8 bits), ranging from “0” to “255”, and quantized data similarly had 256 grayscales (8 bits). Of course, similar advantageous results are obtained even when the number of grayscales is 128 (7 bits), 512 (9 bits), or various other numbers of grayscales.

In the above examples, a printer was used as an example of an image processing device 20. Of course, the device may be a photocopier, fax machine, or a hybrid device having several of these functions; and the host computer 10 may be a portable telephone, PDA (Personal Digital Assistant), digital camera, or other portable information terminal.

What is claimed is:

1. An image processing device, which divides an input image into pixel groups having a plurality of pixels and performs quantization processing in units of said pixel groups, comprising:
a quantization unit which converts input image data into output image data having two or more grayscales, using said pixel groups the shapes of which are point-symmetric.

2. The image processing device according to claim 1, wherein at least one pixel constituting each of said pixel groups is common to a plurality of said pixel groups.

3. The image processing device according to claim 2, wherein the pixel held in common by said pixel groups is a pixel which is at an equal distance from the center of each of said pixel groups.

4. The image processing device according to claim 2, wherein a commonality level is set for each pixel constituting said pixel groups, and for said common pixel, the commonality level is set according to the number of said pixel groups to which the common pixel is common.

5. The image processing device according to claim 1, wherein said quantization unit comprises:
a center-of-gravity position determination unit which determines the center-of-gravity position of said pixel groups from values obtained by multiplying said input image data for each of said pixels included in said pixel group by said commonality level;
a position unit which positions the center of a multivalued dithering matrix, applied in units of said pixel groups, at the center-of-gravity positions of said pixel groups; and,
an output unit which compares said positioned multivalued dithering matrix with said input image data for each of said pixels included in said pixel group, to obtain said output image data.

6. The image processing device according to claim 5, wherein table numbers of tables indicating the correspondence relation between said input image data and output values are stored in said multivalued dithering matrix, and said output unit references said table number of said multivalued dithering matrix corresponding to the position of each pixel included in said pixel group to obtain output values from said input image data, and outputs, as said output image data, values obtained by multiplying said output values by said commonality levels.

7. The image processing device according to claim 4 or claim 5, wherein said output unit ends said quantization processing in said pixel group when an ideal grayscale value has been obtained based on the sum of values obtained by multiplying said input image data for each pixel in said pixel group by said commonality level.

8. The image processing device according to claim 4 or claim 5, wherein said output unit comprises a supplement unit which, when an ideal grayscale value based on the sum of values obtained by multiplying said input image data for each pixel in said pixel group by said commonality levels is not obtained, performs supplement processing such that the sum of said input image data in said pixel group becomes substantially said ideal grayscale value.

9. An image processing device, which divides an input image into pixel groups having a plurality of pixels and performs quantization processing in units of said pixel groups, comprising:
a quantization unit, which converts input image data into output image data having two or more grayscales, using said pixel groups in which the center position of said pixel group and the center position of any pixel included in said pixel group coincide.

10. An image processing method, which divides an input image into pixel groups having a plurality of pixels and performs quantization processing in units of said pixel groups, comprising the step of:
converting input image data into output image data having two or more grayscales, using said pixel groups the shapes of which are point-symmetric.

11. An image processing method, which divides an input image into pixel groups having a plurality of pixels and performs quantization processing in units of said pixel groups, comprising the step of:
converting input image data into output image data having two or more grayscales, using said pixel groups in which the center position of said pixel group and the center position of any pixel included in said pixel group coincide.

12. An image processing program, which divides an input image into pixel groups having a plurality of pixels and performs quantization processing in units of said pixel groups, the image processing program causing a computer to execute:
processing to convert input image data into output image data having two or more grayscales, using said pixel groups the shapes of which are point-symmetric.

13. An image processing program, which divides an input image into pixel groups having a plurality of pixels and performs quantization processing in units of said pixel groups, the image processing program causing a computer to execute:
processing to convert input image data into output image data having two or more grayscales, using said pixel groups, in which the center position of said pixel group and the center position of any pixel included in said pixel group coincide.
